(19) United States
(12) Patent Application Publication
(10) Pub. No.: US 2026/0273685 A1
(43) Pub. Date: Sep. 17, 2026

(54) ROTARY GRINDING TOOL

(71) Applicant: MAKITA CORPORATION, Anjo-shi (JP)

(72) Inventor: Fumitoshi NUMATA, Anjo-shi (JP)

(73) Assignee: MAKITA CORPORATION, Anjo-shi (JP)

(21) Appl. No.: 19/567,663

(22) Filed: Mar. 16, 2026

(30) Foreign Application Priority Data
Mar. 17, 2025 (JP) 2025-042778

(51) Int. Cl. B24B 23/02; B25F 5/00; B25F 5/02

(52) U.S. Cl. CPC B24B 23/028; B25F 5/001; B25F 5/008; B25F 5/026

(57) ABSTRACT

A rotary grinding tool includes a first housing and a second housing. The first housing includes a final output shaft on which a tip tool is mounted and a drive unit that rotates the final output shaft. The second housing includes a handle portion. The tip tool that rotates together with the final output shaft has a grinding surface capable of grinding a workpiece. The first housing is connected to the second housing in a relatively movable manner in a direction intersecting with the grinding surface, and is elastically held by an elastic body interposed between the first housing and the second housing at least in the intersecting direction.

### CROSS REFERENCE TO RELATED APPLICATION

This application claims the benefit of Japanese Patent Application Number 2025-042778 filed on Mar. 17, 2025, the entirety of which is incorporated by reference.

### FIELD OF THE INVENTION

The present disclosure relates to a rotary grinding tool that rotates a tip tool to grind a workpiece. Examples of the rotary grinding tool include a grinder. The term “grinding” also encompasses “polishing” in the present disclosure.

### BACKGROUND OF THE INVENTION

In a grinder as an exemplary rotary grinding tool, a spindle projects downward from a front portion of a housing that accommodates a motor and extends in a front-rear direction, and a tip tool, such as a disk-shaped grinding wheel, is installed on a lower end of the spindle, as disclosed in JP2020-199627A. Accordingly, a grinding operation on a workpiece is possible with the tip tool that rotates together with the spindle.

In particular, in the grinder in JP2020-199627A, the housing includes an inner housing that accommodates the motor and an outer housing that internally has the inner housing and has a handle in a rear part. The inner housing and the outer housing are connected in a relatively rotatable manner via a connecting rod in an up-down direction parallel to the spindle in order to reduce transfer of vibrations and a reactive force generated during the operation to an operator. The inner housing is disposed in front of the connecting rod and is elastically held by the outer housing via a tubular rubber, which allows for reducing the vibrations and the reactive force transferred to the outer housing.

As a measure for improving the grinding operation efficiency of a grinder, a method that avoids a decrease in rotation speed of the tip tool caused by a load during grinding by, for example, improving the motor specification to a low rotation and high torque type is known. However, since there is a limit to improving motor specifications, further measures to improve grinding operation efficiency has been sought.

Therefore, the applicant has verified a processing state of a workpiece with the rotating tip tool by, for example, using a high speed camera. It was then confirmed that the tip tool is not in constant contact with the workpiece. That is, the tip tool undergoes fine up-and-down vibrations during rotation, and separates from the workpiece for an extremely short time. Since the instants where the tip tool is not in contact with the workpiece recur, the grinding is in fact carried out intermittently. That is, the tip tool jumps upward at the moment of contacting the workpiece and idles, and therefore, the grinding is not performed during the idling period.

Accordingly, based on the verification result, the applicant has conceived that if the up-and-down motion of the tip tool is reduced and the idling period is successfully reduced, a contact period per unit time between the tip tool and the workpiece may be increased, which may lead to the improvement in the grinding operation efficiency. JP2020-199627A discloses that the inner housing is elastically held to reduce a reaction torque against the rotation of the tip tool. However, it is not so sufficient in reducing the up-and-down motion of the tip tool.

Therefore, it is an object of the disclosure to provide a rotary grinding tool that increases a contact period of a tip tool with a workpiece for improving grinding operation efficiency.

### SUMMARY OF THE INVENTION

In order to achieve the above-described object, the present disclosure provides a rotary grinding tool including a first housing and a second housing. The first housing includes a final output shaft on which a tip tool is mounted and a drive unit that rotates the final output shaft. The second housing includes a handle portion. The tip tool that rotates together with the final output shaft has a grinding surface that grinds a workpiece. The first housing is connected to the second housing in a relatively movable manner in a direction intersecting with the grinding surface, and is elastically held by an elastic body interposed between the first housing and the second housing at least in the intersecting direction.

With the disclosure, a degree of freedom of a relative movement of a first housing with respect to a second housing is increased in a direction intersecting with a grinding surface, while the first housing is elastically held. As a result, movement of the tip tool in the intersecting direction during a grinding operation can be effectively reduced. Accordingly, the tip tool that has separated from the workpiece promptly returns to a contact position with the workpiece. In view of this, the contact period of the tip tool with the workpiece increases, which leads improvement in the grinding operation efficiency.

### BRIEF DESCRIPTION OF THE DRAWINGS

FIG. 1 is a perspective view of a grinder as viewed from the rear.

FIG. 2 is a center vertical cross-sectional view of the grinder.

FIG. 3 is an enlarged view of a driving portion in FIG. 2.

FIG. 4 is an exploded perspective view illustrating an elastically holding structure of an inner housing as viewed from the front.

FIG. 5 is an exploded perspective view illustrating the elastically holding structure of the inner housing as viewed from the rear.

FIG. 6 is a partial cross-sectional view taken along the line A-A in FIG. 3.

FIG. 7 is a partial cross-sectional view taken along the line B-B in FIG. 3.

FIG. 8 is a partial cross-sectional view taken along the line C-C in FIG. 3.

FIG. 9 is a partial cross-sectional view taken along the line D-D in FIG. 3.

FIG. 10 is an explanatory view illustrating a grinding operation by the grinder in which a left-side half housing of an outer housing is omitted from the grinder.

### DETAILED DESCRIPTION OF THE INVENTION

In one embodiment of the present disclosure, the first housing may be connected to the second housing via a fulcrum shaft parallel to the grinding surface.

The configuration allows for easily achieving a relative movement of the first housing with respect to the second housing in a direction intersecting with the grinding surface.

In one embodiment of the present disclosure, the first housing may be elastically held by the elastic body on a side of the tip tool with respect to the fulcrum shaft.

The configuration allows for elastically permitting a relative rotation of the first housing about the fulcrum shaft with the elastic body.

In one embodiment of the present disclosure, the first housing may have a tubular shape, the second housing may have a tubular shape overlapping the first housing in a radial direction, and the elastic body may have a tubular shape interposed in an overlapping portion between the first housing and the second housing.

The configuration allows for easily performing elastically holding the first housing within the second housing, and obtaining also an insulating effect of vibrations from the first housing to the second housing.

In one embodiment of the present disclosure, the first housing may have a tubular shape extending in a front-rear direction and has the final output shaft oriented in an up-down direction in a front portion of the first housing, the second housing may have a tubular shape that extends in the front-rear direction coaxially with the first housing, and the fulcrum shaft may be disposed in a right-left direction on the first housing.

The configuration allows for easily providing the fulcrum shaft using the first housing.

In one embodiment of the present disclosure, the first housing may accommodate a motor constituting the drive unit and may include a bearing holding portion that holds a bearing of a rotation shaft of the motor in a rear portion of the first housing, and the fulcrum shaft may be disposed on right and left side surfaces of the bearing holding portion.

The configuration allows for providing the fulcrum shaft in the first housing using a dead space outside the bearing holding portion.

In one embodiment of the present disclosure, the fulcrum shaft may be elastically held by the second housing via a second elastic body.

The configuration allows for obtaining an insulating effect against the vibrations from the first housing to the second housing with the second elastic body.

In one embodiment of the present disclosure, the second elastic body may have a ring shape or a tubular shape.

The configuration allows for obtaining an insulating effect against vibrations over a whole circumference around an axis line of the fulcrum shaft.

In one embodiment of the present disclosure, the second housing may be provided with a handle attachment portion for attaching an auxiliary handle.

With the configuration, the vibrations are less likely to be transferred to a hand of an operator who holds the auxiliary handle.

In one embodiment of the present disclosure, the handle attachment portion may be arranged outside the elastic body.

The configuration allows for more effectively obtaining a vibration reducing effect for the auxiliary handle.

The following describes embodiments of the disclosure based on the drawings.

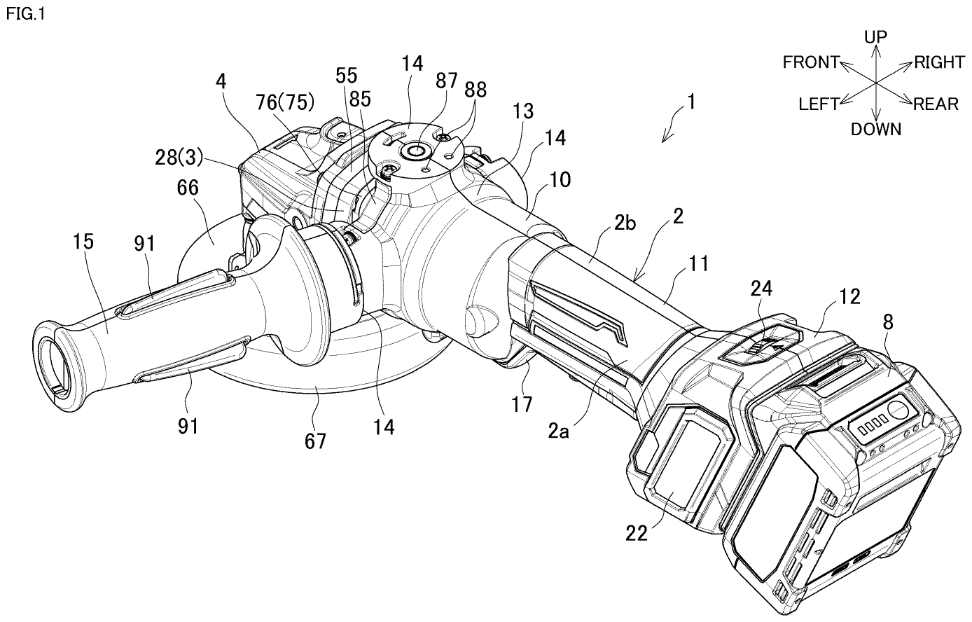

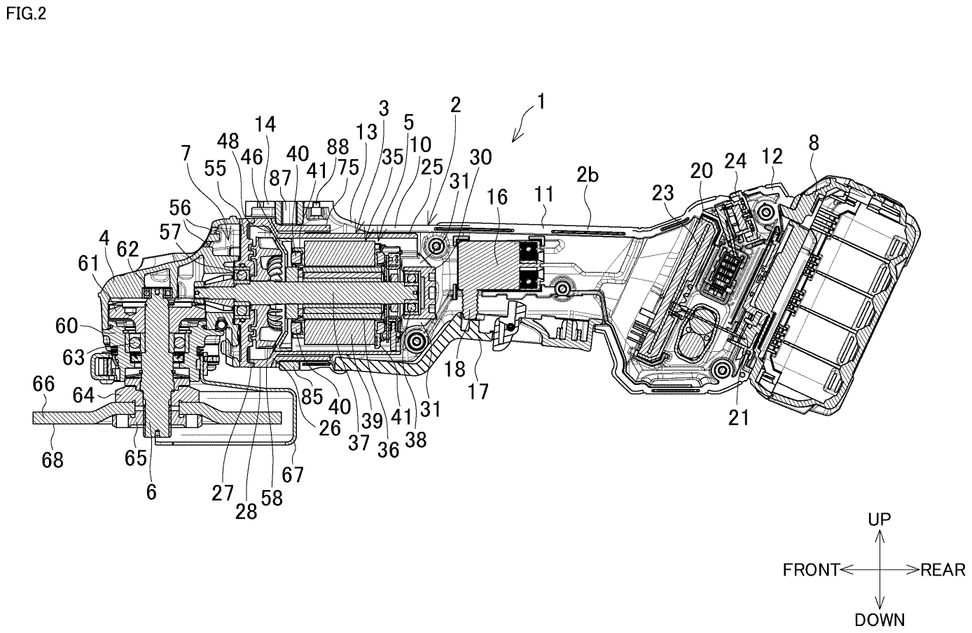

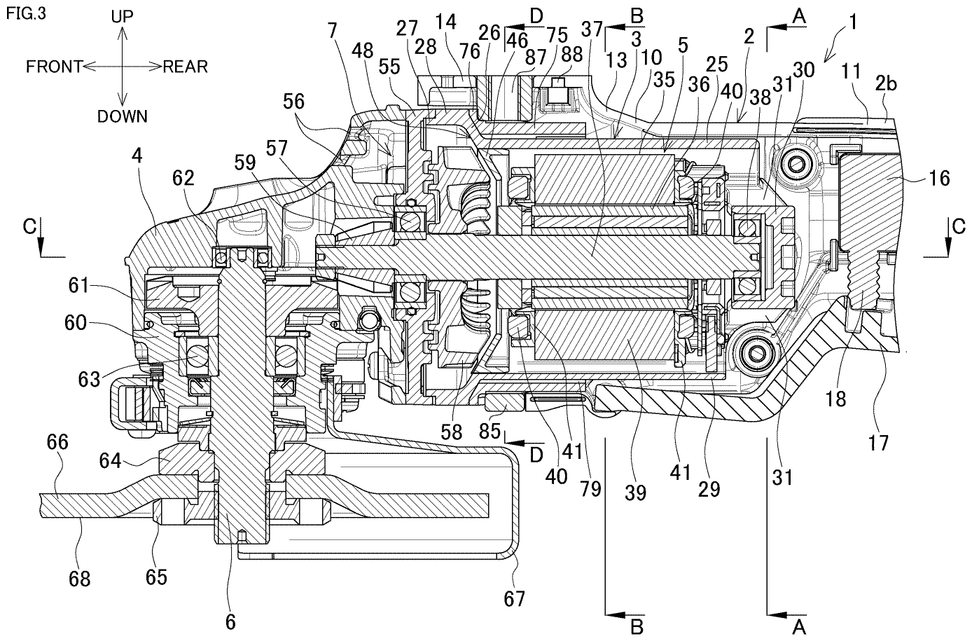

FIG. 1 is a perspective view illustrating a grinder as an exemplary rotary grinding tool. FIG. 2 is a center vertical cross-sectional view of the grinder. FIG. 3 is an enlarged view of a front side portion in FIG. 2.

A grinder 1 includes an outer housing 2 that forms an outline, an inner housing 3 that accommodates a motor 5, and a gear housing 4 that forms the outline and has a spindle 6, as housings. Within the inner housing 3 and the gear housing 4, a drive unit 7 including the motor 5 and a spindle 6 is disposed. The outer housing 2 has a rear end on which a battery pack 8 serving as a power source is detachably mounted.

The outer housing 2 is one example of the second housing of the disclosure. The inner housing 3 and the gear housing 4 are one example of the first housing of the disclosure. The spindle 6 is an example of the final output shaft of the disclosure.

The outer housing 2 is made of resin in a tubular shape extending in a front-rear direction, and integrally forms a front cylinder portion 10, a rear cylinder portion 11, and a battery mounting portion 12 in this order from the front. The outer housing 2 is formed by assembling a pair of right and left half housings 2a, 2b by screwing.

The front cylinder portion 10 elastically holds the inner housing 3 inside. The elastically holding structure will be described later. The front cylinder portion 10 has a front end serving as an expanded portion 13 expanding as approaching the front part. Handle attachment portions 14 for mounting a side handle 15 are disposed at three locations on an upper surface and right and left side surfaces of the expanded portion 13. The side handle 15 is an example of the auxiliary handle of the disclosure.

The rear cylinder portion 11 has a diameter smaller than that of the front cylinder portion 10 and is connected to the front cylinder portion 10 at an eccentric position on an upper side of the front cylinder portion 10. Within the rear cylinder portion 11, a main switch 16 and a switch lever 17 are disposed. The main switch 16 is held within the rear cylinder portion 11 in the posture with a plunger 18 protruding downward. The switch lever 17 is swingable up and down with its front end as a fulcrum, and is biased to the lower limit position protruding downward from a lower surface of the rear cylinder portion 11 by the plunger 18 that is biased to protrude. The operation of holding the rear cylinder portion 11 and pushing the switch lever 17 upward allows for pushing in the plunger 18 and turning ON the main switch 16. The rear cylinder portion 11 is an example of the handle portion of the present disclosure.

The battery mounting portion 12 accommodates a controller 20 in the front side and a terminal block 21 in the rear side in an inclined posture such that the respective lower ends are positioned further forward than the upper ends. An air inlet 22 is formed on a side surface of the battery mounting portion 12 and between the controller 20 and the terminal block 21. The controller 20 internally includes a control circuit board 23 on which a microcomputer, a memory, and the like are mounted, and controls driving of the motor 5. An adjustment dial 24 is disposed in a rear position of the controller 20 and in an upper portion of the battery mounting portion 12. The rotating operation of the adjustment dial 24 allows for adjusting the rotation speed of the motor 5. The terminal block 21 is electrically connected to the battery pack 8 slidably mounted on a rear end of the battery mounting portion 12.

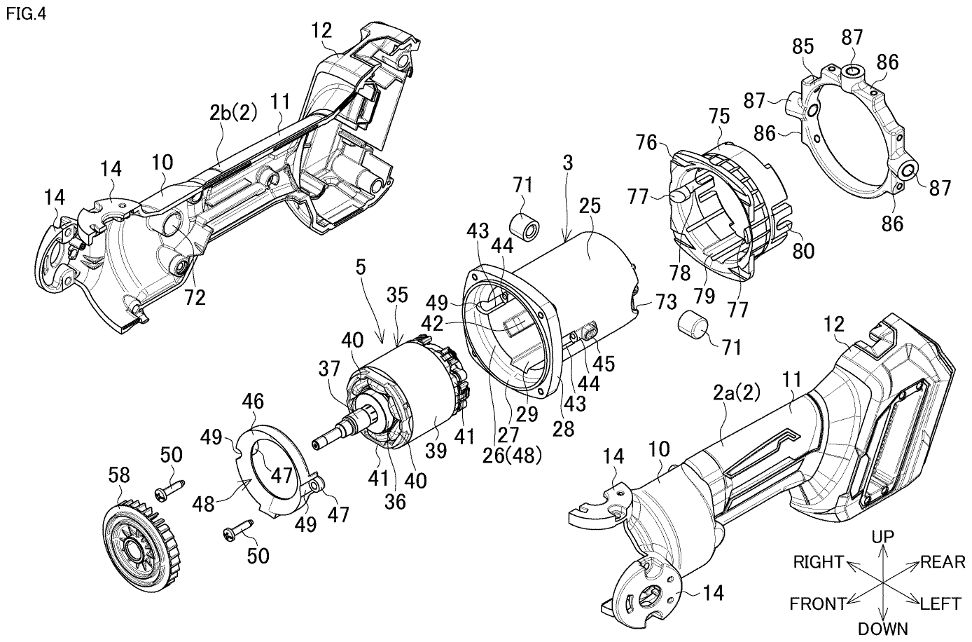

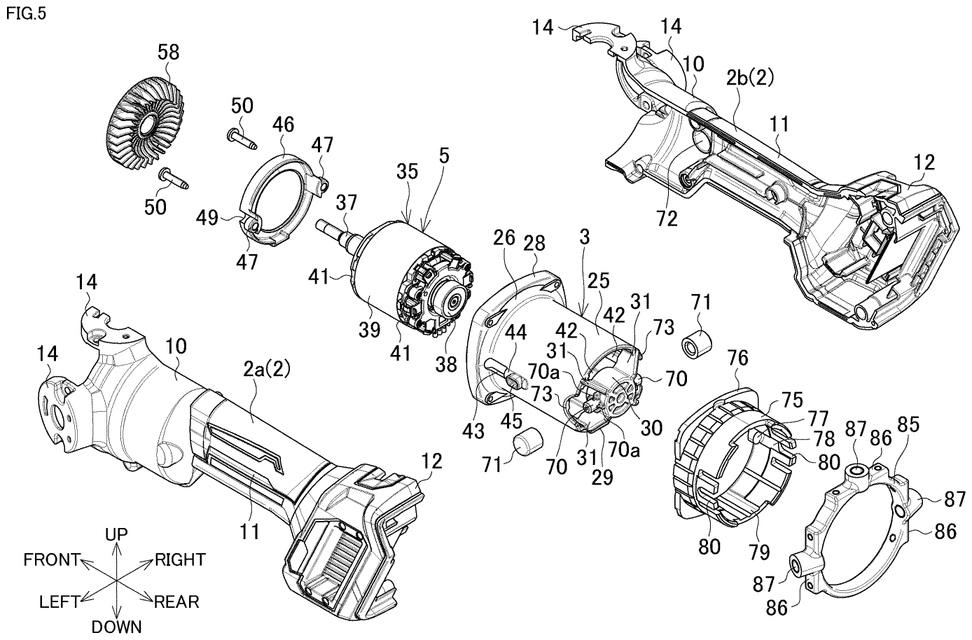

The inner housing 3 is a tubular body made of resin, and has a tubular main body 25 having a diameter smaller than that of the front cylinder portion 10 to fit within the front cylinder portion 10. The tubular main body 25 has a front portion protruding forward from the outer housing 2. The front portion is provided with a tapered portion 26, a large diameter portion 27, and a flange portion 28 as illustrated in FIG. 4 and FIG. 5. The tapered portion 26 is expanded so as to have a large diameter as approaching forward. The large diameter portion 27 extends in an equal diameter forward from a front end of the tapered portion 26 and has a diameter larger than that of the front cylinder portion 10. The flange portion 28 is formed on an outer periphery of the large diameter portion 27 inside each of the handle attachment portions 14 and is in a square shape in front view. On a lower surface of the inner housing 3, a fitting protrusion 29 is formed. The fitting protrusion 29 is a strip-shaped protruding portion having a predetermined left-right width and protruding downward, and is formed in the front-rear direction from the tapered portion 26 to the rear end of the tubular main body 25.

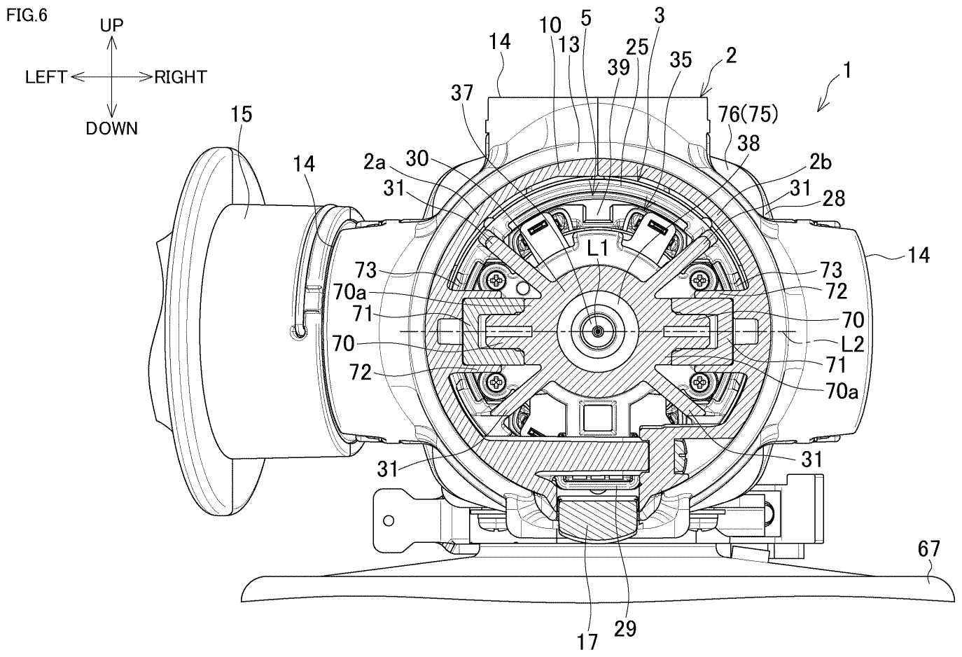

The inner housing 3 has a rear portion provided with a bearing holding portion 30. The bearing holding portion 30 is a closed-end cylinder and the front part is opened. A diameter of the bearing holding portion 30 is smaller than that of the tubular main body 25. Between an outer surface of the bearing holding portion 30 and an inner surface of the tubular main body 25, four connecting plates 31 extending radially from the bearing holding portion 30 are formed as illustrated in FIG. 6. Accordingly, the bearing holding portion 30 is coaxially supported with the tubular main body 25 by the connecting plates 31. The bearing holding portion 30 has a rear portion protruding rearward with respect to the rear end of the tubular main body 25 in the supported state.

The motor 5 is an inner rotor type brushless motor constituted of a tube-shaped stator 35 and a rotor 36 passing through the inside of the stator 35. A rotation shaft 37 disposed in the center of the rotor 36 protrudes forward with respect to the inner housing 3. The rotation shaft 37 has a rear end supported by a bearing 38 held by the bearing holding portion 30.

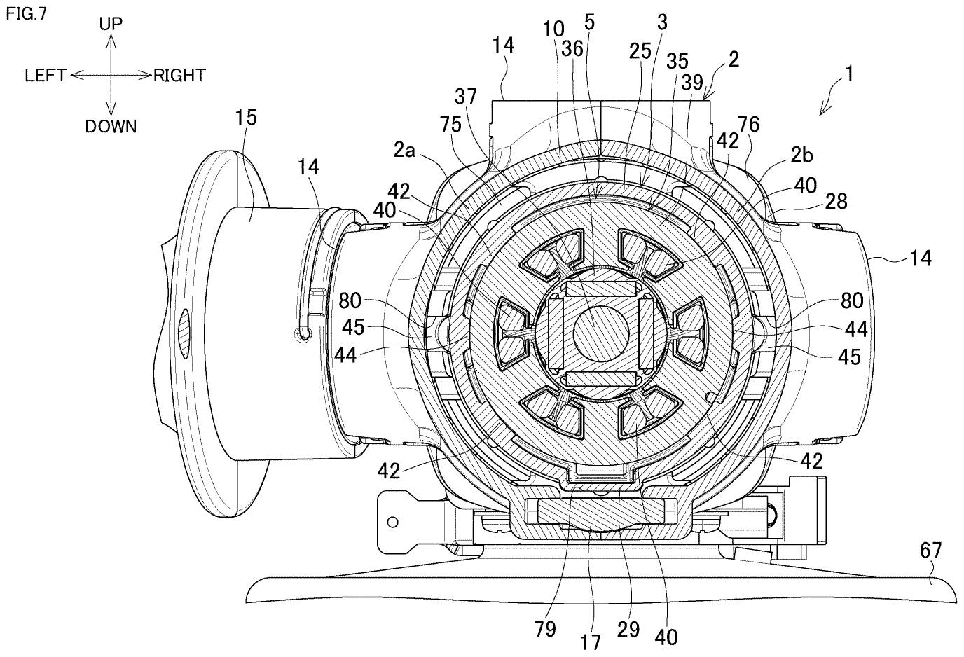

The stator 35 includes a stator core 39 around which a plurality, namely six here, of coils 40 are wound, and ring-shaped insulators 41 disposed respectively in front and behind of the stator core 39. The tubular main body 25 has an inner surface on which a plurality, namely four here, of protruding portions 42 are disposed at regular intervals in a circumferential direction to hold an outer peripheral surface of the stator core 39 as illustrated in FIG. 4 and FIG. 7. The protruding portions 42 support the stator 35 coaxially with the tubular main body 25. Each of the protruding portions 42 has a rear portion where a lock portion (not illustrated) that protrudes toward the center side of the tubular main body 25 is provided and is locked to the rear insulator 41 in the rear side. Accordingly, the stator 35 is prevented from rotating inside the tubular main body 25.

In the front portion of the tubular main body 25, a pair of slits 43 are formed on the left and right sides at positions that are point symmetric about the axis. Each of the slits 43 has a front end notched from the tapered portion 26 and extends rearward. On the rearward extension lines of the respective slits 43, screw boss portions 44 protruding toward the outer surface of the tubular main body 25 are respectively formed. On right and left outer surfaces of the screw boss portions 44, lock protrusions 45 protruding outward to the right and left are formed. Each of the lock protrusions 45 has an oval-like shape in side view extending in the front-rear direction.

A baffle plate 46 is assembled from the front in the front side of the stator 35 in the tubular main body 25. The baffle plate 46 has a ring shape made of resin whose front surface serves as a tapered surface continuously connecting to the front surface of the tapered portion 26. A pair of small tubular portions 47 are disposed so as to protrude radially outward on the right and left sides of the baffle plate 46. The small tubular portions 47 fit into the slits 43 of the tubular main body 25 and abut against the screw boss portions 44 from the front.

The baffle plate 46 is assembled from the front onto the tubular main body 25 in which the stator 35 is inserted. At this time, the right and left small tubular portions 47 are positioned at the front side of the screw boss portions 44 via the slits 43, and are pushed rearward. The rear ends of the small tubular portions 47 then abut on the front surface of the stator core 39, and position the stator 35 from the front.

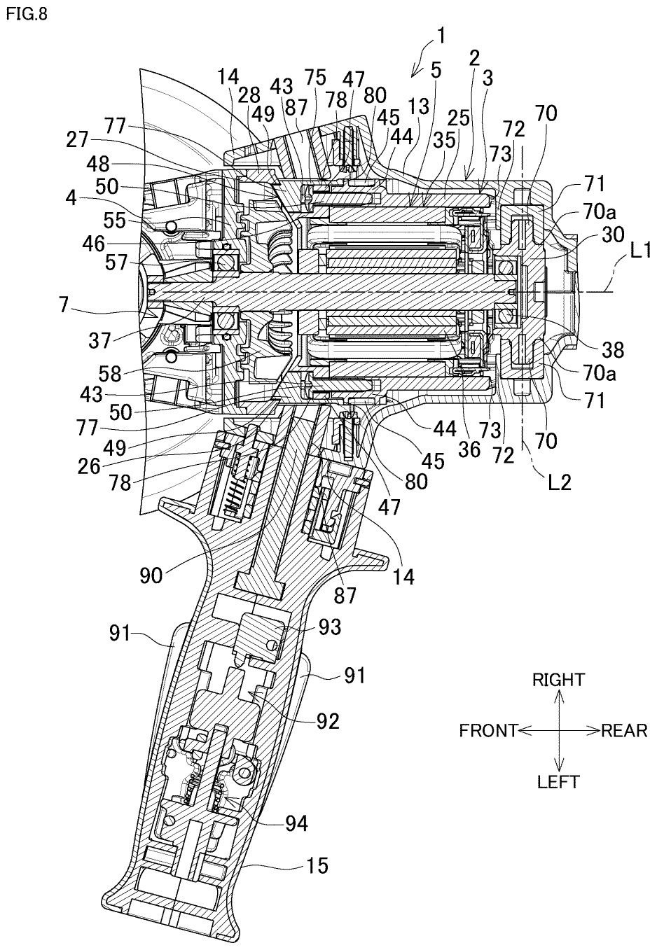

In this positioning state, the tapered portion 26 and the baffle plate 46 form a cone-shaped rectifier 48 in a rear side of a fan 58 described later as illustrated in FIG. 8.

The rectifier 48 has through-holes 49 in circular shapes in front view formed by respective cutouts in semicircular shapes in front view formed on the right and left of the tapered portion 26 and the baffle plate 46. Screws 50 passing through the small tubular portions 47 from the front via the through-holes 49 are screwed into the screw boss portions 44. The baffle plate 46 is then secured at a position where the rectifier 48 is formed and sandwiches and secures the stator 35 with the lock portions disposed on the respective protruding portions 42 of the tubular main body 25.

The gear housing 4 is fastened with screws from the front part onto the flange portion 28 of the tubular main body 25 of the inner housing 3 via a gear housing cover 55. The gear housing 4 has a front surface on which a plurality of exhaust outlets 56 communicated with the inside of the tubular main body 25 are formed. The rotation shaft 37 has a front portion that passes through the gear housing cover 55 and protrudes into the gear housing 4. The gear housing cover 55 is provided with a bearing 57 that supports the rotation shaft 37. Behind the gear housing cover 55, the fan 58, which is a centrifugal fan, is secured to the rotation shaft 37.

The rotation shaft 37 has a front end to which a bevel gear 59 is secured in the gear housing 4. The gear housing 4 has a lower portion to which a bearing box 60 is assembled. The spindle 6 is disposed in the up-down direction inside the gear housing 4 and the bearing box 60. The spindle 6 includes a bevel gear 61 in the upper portion. The bevel gear 61 engages with the bevel gear 59 of the rotation shaft 37.

The spindle 6 is rotatably supported by upper and lower bearings 62, 63 held inside the gear housing 4 and the bearing box 60. The spindle 6 has a lower end protruding downward from the bearing box 60. At the lower end of the spindle 6, a tip tool 66, for example, a disk-shaped grinding wheel, is detachably mounted by an inner flange 64 and a locknut 65. A wheel cover 67 that covers the rear upper side and the rear side of the tip tool 66 is mounted on the bearing box 60.

Next, an elastically holding structure for the inner housing 3 will be described in detail.

As illustrated in FIG. 5, FIG. 6, and FIG. 8, the bearing holding portion 30 of the inner housing 3 has right and left side surfaces on which fulcrum shafts 70 protruding outward to the right and left are formed. The fulcrum shafts 70 are arranged coaxially with an axis line L2 in a right-left direction perpendicular to an axis line L1 of the tubular main body 25 and the bearing holding portion 30, which are coaxial. Rubber caps 71 are put on the respective fulcrum shafts 70. The rubber caps 71 are in tubular shapes with the bottoms closing right and left outer side surfaces, and have open-side end portions abutting on ribs 70a in a cross shape in side view formed at the base of the fulcrum shaft 70 on the side surface of the bearing holding portion 30. The rubber cap 71 is one example of the tubular-shaped second elastic body of the disclosure.

The half housings 2a, 2b of the outer housing 2 have inner surfaces on which respective receiving pipes 72 are disposed to protrude. The receiving pipes 72 are formed coaxially with the axis line L2 of the fulcrum shafts 70 and are opposed to one another. Each of the receiving pipes 72 holds the rubber cap 71.

The tubular main body 25 has right and left rear ends where cutouts 73 in semicircular shapes in side view are formed. The cutout 73 is formed to have a radius larger than that of the receiving pipe 72, and is caused not to overlap the receiving pipe 72 in the right-left direction.

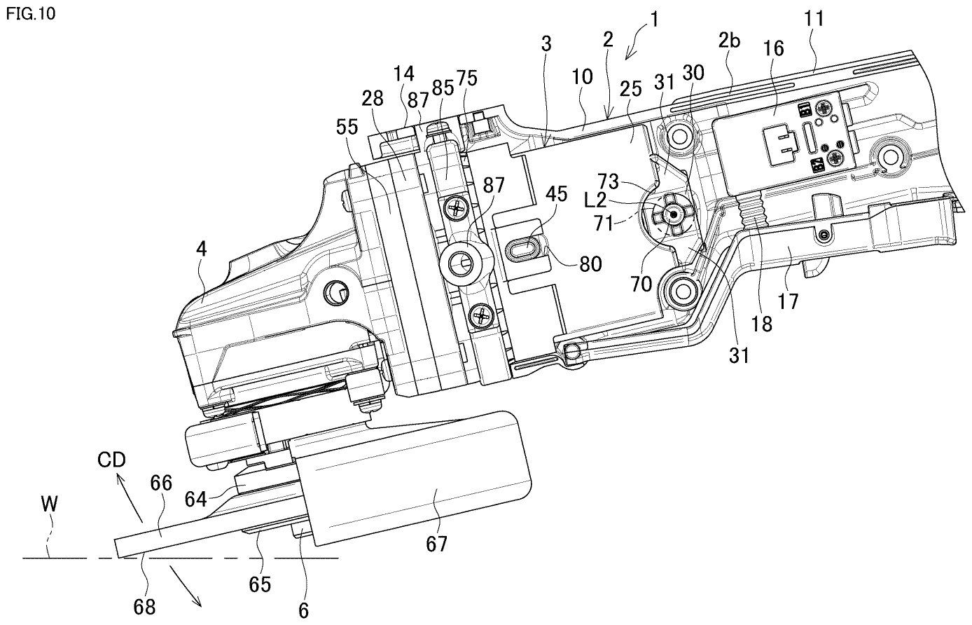

The fulcrum shafts 70 is thus held in the right and left receiving pipes 72 via the rubber caps 71. Accordingly, the inner housing 3 and the gear housing 4 integral with the inner housing 3 are held with the fulcrum shafts 70 as the center elastically and swingably in the up-down direction. This up-down direction corresponds to a direction CD that intersects with a grinding surface 68 on the lower surface of the tip tool 66 mounted on the spindle 6, as shown in FIG. 10.

On the other hand, the tubular main body 25 of the inner housing 3 has an outer periphery on which a tubular rubber 75 is externally mounted so as to extend from the tapered portion 26 to the rearward of the tapered portion 26. The tubular rubber 75 is interposed between a front side portion of the outer housing 2 with respect to the expanded portion 13 and a front side portion of the tubular main body 25. The tubular rubber 75 has a front end serving as a rubber flange portion 76 in a square shape in front view, which is an approximately the same shape as the flange portion 28 of the tubular main body 25. The tubular rubber 75 is an example of the elastic body of the disclosure.

The inner housing 3 is swingable up and down about the fulcrum shafts 70 that are elastically held by the rubber caps 71. Accordingly, the whole circumference of the tubular main body 25 is elastically held, forward of the fulcrum shafts 70, by the outer housing 2 in a coaxial manner via the tubular rubber 75. Here, the rubber cap 71 has a hardness lower than that of the tubular rubber 75.

A pair of inner positioning protrusions 77 are formed at positions in a front end side on the right and left inner circumference surfaces in the tubular rubber 75. The inner positioning protrusions 77 are in circular shapes in front view and fit to the through-holes 49 provided in the rectifier 48 as illustrated in FIG. 8. In this state, the inner positioning protrusions 77 serve as spacers that close the front part of the screws 50 that secure the baffle plate 46. At the same time, the inner positioning protrusions 77 have front surfaces serving as parts of the rectifier 48 continuous with front surfaces of the tapered portion 26 and the baffle plate 46. Semicircular-shaped groove portions 78 are formed to extend in the front-rear direction on the inner circumference surface of the tubular rubber 75 in the rear part of the respective inner positioning protrusions 77. The respective groove portions 78 fit to the screw boss portions 44 of the tubular main body 25.

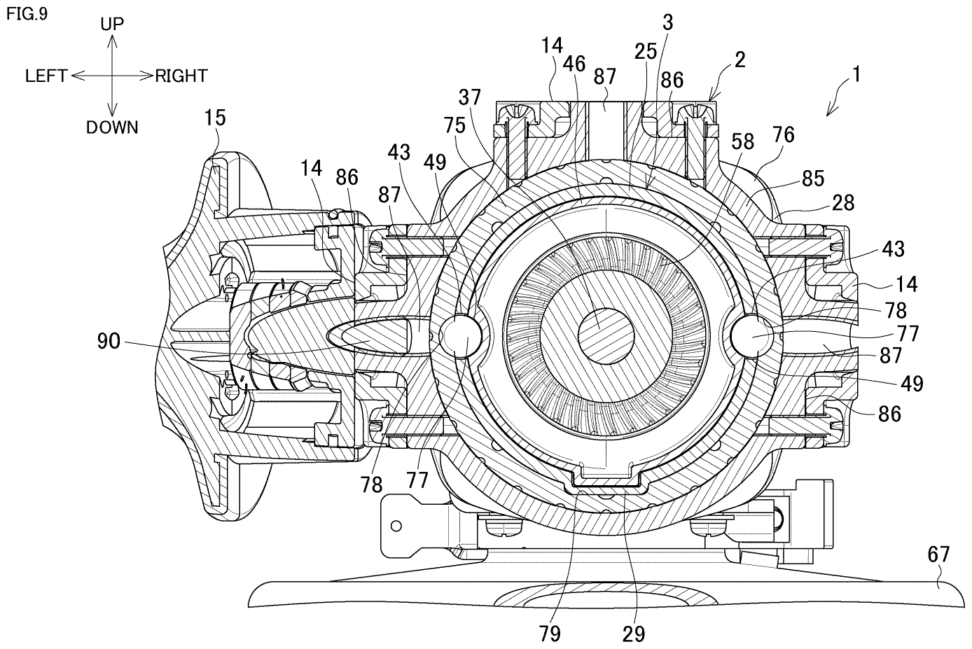

The tubular rubber 75 has a lower-side inner circumference surface on which a positioning groove 79 is formed over the whole length in the front-rear direction. The positioning groove 79 is fitted with the fitting protrusion 29 disposed in the lower portion of the tubular main body 25 as illustrated in FIG. 9.

On right and left side surfaces in the rear end of the tubular rubber 75, notches 80 are formed forward from the rear end. The notches 80 are locked onto the lock protrusions 45 disposed on the right and left side surfaces of the tubular main body 25 as illustrated in FIG. 7 and FIG. 10 to restrict displacement of the tubular rubber 75 in the rotation direction.

The tubular main body 25 of the inner housing 3 has a metallic securing ring 85 externally mounted via the tubular rubber 75 as illustrated also in FIG. 9 and FIG. 10. The securing ring 85 has an upper surface and right and left side surfaces on which plane surface portions 86 extending in a tangential direction of the securing ring 85 are respectively formed. Screw-hole portions 87 that protrude outward in the radial direction are formed on the respective plane surface portions 86. The screw-hole portions 87 on the right and left plane surface portions 86 face outward to the right and left and incline forward as illustrated in FIG. 8.

Each of the handle attachment portions 14 of the outer housing 2 protrudes forward from the expanded portion 13 and has a circular shape in plan view or side view. The respective handle attachment portions 14 have a pedestal-shaped configuration that projects radially outward with respect to the expanded portion 13, and are screwed onto the corresponding plane surface portions 86. The screw-hole portions 87 pass through the centers of the respective handle attachment portions 14 in the screwed state, and thus, the screw holes are exposed. The right and left handle attachment portions 14 face outward to the right and left and incline forward to correspond to the inclination of the right and left screw-hole portions 87. The respective handle attachment portions 14 are provided with a pair of positive and negative machine-side terminals 88 as illustrated in FIG. 1 and FIG. 2. Each of the machine-side terminals 88 is electrically connected to the control circuit board 23 of the controller 20 via a lead wire (not illustrated) passing between the outer housing 2 and the inner housing 3.

The side handle 15 includes a screw portion 90 and a pair of positive and negative handle-side terminals (not illustrated) in a mounting end portion mounted onto the handle attachment portion 14 as illustrated in FIG. 8. The side handle 15 has an outer periphery provided with three levers 91. A grip detecting mechanism 92 is disposed within the side handle 15. The grip detecting mechanism 92 includes a switch 93 electrically connected to the handle-side terminal and a link portion 94 that turns ON the switch 93 by gripping the lever 91.

By threadably engaging and screwing the screw portion 90 into a screw hole of any one of three screw-hole portions 87, the side handle 15 is mounted onto the handle attachment portion 14. As a result, the handle-side terminal is brought into contact with the machine-side terminals 88 to provide a conductive state. Gripping the lever 91 in this state causes the link portion 94 to turn ON the switch 93, and an ON signal is output to the controller 20 via the handle-side terminal and the machine-side terminal 88.

With the grinder 1 configured as described above, the side handle 15 is gripped together with the lever 91 with one hand in the state where the side handle 15 is mounted onto any one of the three handle attachment portions 14. The switch 93 of the grip detecting mechanism 92 then is turned ON as described above.

The main switch 16 is turned ON by gripping the switch lever 17 with the other hand while holding the rear cylinder portion 11 of the outer housing 2. When the controller 20 confirms the ON signal of the switch 93 of the grip detecting mechanism 92 and the ON signal of the main switch 16, it supplies the power of the battery pack 8 to the motor 5 to be driven. Accordingly, the rotation shaft 37 rotates to rotate the spindle 6 in a clockwise direction when viewed from above via the bevel gears 59, 61, and thus, the grinding operation of the workpiece with the tip tool 66 becomes possible.

The inner housing 3 and the gear housing 4 are swingable together with the drive unit 7 inside in the direction CD that intersects with the grinding surface 68 as indicated by the arrow in FIG. 10 about the fulcrum shafts 70 oriented in the right-left direction parallel to the grinding surface 68, namely the axis line L2. The tubular rubber 75 is interposed between the inner housing 3 and the outer housing 2, which elastically supports the whole circumference including the direction CD.

In view of this, even when the tip tool 66 that grinds the workpiece W with the grinding surface 68 on the lower surface including the outer peripheral edge attempts to slightly vibrate up and down, the up-and-down motion of the tip tool 66 is absorbed by the tubular rubber 75 and is effectively reduced. Accordingly, the recovery of the tip tool 66 separated from the workpiece W to the contact position with the workpiece W is accelerated, which allows for reducing an idling period of the tip tool 66 to increase the contact period with the workpiece W, thereby leading to the improvement of the grinding operation efficiency.

A grinding test with the above-described exemplary structure was performed and resulted in successfully confirming a 20% to 30% extended contact period per unit time, namely one minute, with respect to a grinder without the elastically holding structure. Accordingly, the grinding operation efficiency was successfully improved by 15% to 20%.

Additionally, even though the vibrations are generated in the drive unit 7, the tubular rubber 75 interposed between the inner housing 3 and the outer housing 2, and the rubber caps 71 interposed between the fulcrum shafts 70 and the receiving pipes 72 effectively insulate the vibrations, and the vibrations to the outer housing 2 are reduced. Accordingly, the vibrations are less likely to be transferred to the hand of the operator holding the rear cylinder portion 11. The side handle 15 is also mounted on the handle attachment portion 14 of the outer housing 2 insulated against the vibrations, and therefore, the vibrations are less likely to be transferred to the hand of the operator holding the side handle 15.

Meanwhile, when the fan 58 rotates in accordance with the rotation of the rotation shaft 37, the external air is suctioned from the air inlet 22 in the rear part and moves forward within the outer housing 2 by passing around from the lower side of the controller 20. This cools the controller 20 and the terminal block 21.

The airflow within the outer housing 2 flows into the tubular main body 25 of the inner housing 3 after passing and cooling the main switch 16, and passes between the stator 35 and the rotor 36 of the motor 5 to cool the motor 5. Thereafter, the airflow passes from the rectifier 48 through the large diameter portion 27, reaches the inside of the gear housing 4 via the gear housing cover 55, and is discharged outside from the exhaust outlet 56.

Thus the grinder 1 of the above-described example includes the inner housing 3 and the gear housing 4 that have the spindle 6 on which the tip tool 66 is mounted and the drive unit 7 that rotates the spindle 6, and the outer housing 2 that has the rear cylinder portion 11, and grinds the workpiece W with the grinding surface 68 of the tip tool 66 that rotates together with the spindle 6.

The inner housing 3 and the gear housing 4 are connected to the outer housing 2 in a relatively movable manner in the direction CD that intersects with the grinding surface 68, and are elastically held at least in the direction CD by the tubular rubber 75 interposed between the inner housing 3 with the gear housing 4 and the outer housing 2.

The configuration allows for effectively reducing the movement of the tip tool 66 in the direction CD during the grinding operation by elastically holding the inner housing 3 while increasing the degree of freedom of the relative movement of the inner housing 3 and the gear housing 4 with respect to the outer housing 2 in the direction CD. Accordingly, the recovery of the tip tool 66 separated from the workpiece W to the contact position with the workpiece W can be accelerated. In view of this, the contact period of the tip tool 66 with the workpiece W is increased, thereby allowing for improving the grinding operation efficiency.

The inner housing 3 is connected to the outer housing 2 via the fulcrum shafts 70 parallel to the grinding surface 68.

Accordingly, the relative movement of the inner housing 3 with respect to the outer housing 2 in the direction CD is easily achievable.

The inner housing 3 is elastically held by the tubular rubber 75 in the tip tool 66 side with respect to the fulcrum shafts 70 in the front-rear direction.

Accordingly, the relative rotation of the inner housing 3 about the fulcrum shafts 70 is elastically permissible by the tubular rubber 75.

The inner housing 3 has a tubular shape, the outer housing 2 has a tubular shape radially overlapping the inner housing 3, and the elastic body is the tubular rubber 75 interposed in the overlapping portion between the inner housing 3 and the outer housing 2.

Accordingly, the inner housing 3 can be easily elastically held within the outer housing 2, and the insulation effect of the vibrations from the inner housing 3 to the outer housing 2 can also be obtained.

The inner housing 3 has a tubular shape extending in the front-rear direction, the gear housing 4 in front of the inner housing 3 includes the spindle 6 in the up-down direction, the outer housing 2 has a tubular shape extending in the front-rear direction coaxially with the inner housing 3, and the fulcrum shafts 70 are provided in the right-left direction to the inner housing 3.

Accordingly, the fulcrum shafts 70 can be easily disposed using the inner housing 3.

The inner housing 3 accommodates the motor 5 constituting the drive unit 7 and includes the bearing holding portion 30 that holds the bearing 38 of the rotation shaft 37 of the motor 5 in the rear part, and the fulcrum shafts 70 are disposed on the right and left side surfaces of the bearing holding portion 30.

Accordingly, the fulcrum shafts 70 can be disposed in the inner housing 3 using the dead space outside the bearing holding portion 30.

The fulcrum shafts 70 is elastically held onto the outer housing 2 via the rubber caps 71.

Accordingly, the insulation effect against the vibrations to the outer housing 2 from the inner housing 3 is obtainable even by the rubber caps 71.

The rubber caps 71 are in the tubular shape.

Accordingly, the insulation effect against the vibrations is obtainable over the whole circumference about the axis line L2 of the fulcrum shafts 70.

The handle attachment portion 14 for mounting the side handle 15 is disposed in the outer housing 2.

Accordingly, the vibrations are less likely to be transferred even to the hand of the operator who holds the side handle 15.

The handle attachment portion 14 is disposed outside the tubular rubber 75.

Accordingly, the vibration reduction effect for the side handle 15 is more effectively obtained.

The following describes modifications of the disclosure.

While the fulcrum shafts are formed on the right and left side surfaces of the bearing holding portion in the above-described example, the structure is not limited to this structure. For example, one fulcrum shaft may be passed through the bearing holding portion in the rear side of the bearing, and the right and left ends may be supported by the outer housing. In this case, the fulcrum shaft may be made of metal.

The structure of the fulcrum shaft is not limited to be disposed in the bearing holding portion. In the case where the bearing holding portion is disposed in the front side with respect to the above-described example, the fulcrum shaft may be disposed in the rear portion of the tubular main body.

While the fulcrum shaft is disposed in the inner housing, and the receiving pipe is disposed in the outer housing in the above-described example, this may be inverted. That is, the same action is obtainable when the fulcrum shaft parallel to the grinding surface is disposed on the inner surface of the outer housing, and the receiving portion, namely, a recessed portion, a through hole, or a tubular portion, that receives the fulcrum shaft is disposed on the outer surface of the inner housing.

The shape of the tubular rubber that elastically holds the inner housing is also changeable as necessary. For example, the tubular rubber may be longer or shorter in the axial direction than the above-described example.

The elastic body is not limited to one member, such as the tubular rubber of the above-described example, and may be divided into, for example, a plurality of plate shapes or arc shapes, and disposed equally in the circumferential direction on the outer periphery of the inner housing. In the case, the elastic body may be disposed to cover only the upper and lower surfaces of the inner housing. A plurality of rubber rings short in the axial direction may be disposed in the axial direction of the inner housing.

The second elastic body that receives the fulcrum shaft may also be a ring-shaped rubber, not a closed-bottom pipe, such as the rubber cap of the above-described example. In the case, a plurality of ring-shaped rubbers may be disposed in the axial direction. A plurality of pin-shaped or plate-shaped rubbers may be disposed around the fulcrum shaft as the second elastic body. However, the second elastic body may be omitted.

While the hardness of the rubber cap as the second elastic body is lower than the hardness of the tubular rubber as the elastic body in the above-described example, the configuration is not limited to this, and the hardness of the elastic body may be lower than the hardness of the second elastic body, or both the elastic bodies may have the same hardness.

The elastic body and the second elastic body of the disclosure may be another elastic body, such as a leaf spring or a coil spring, not the rubber as in the above-described example.

The structure of the inner housing and the outer housing is not limited to the above-described example. For example, the outer housing does not have to be of a split structure, and the inner housing may be of a split structure.

While the first housing exemplified by the inner housing is overlapped with the second housing exemplified by the outer housing from the outside in the radial direction in the above-described example, this may be inverted. That is, the first housing having the drive unit may overlap the second housing having the handle portion from the outside in the radial direction to be connected to the second housing via the fulcrum shaft, and the elastic body may be interposed in the overlapping portion between the first housing and the second housing in the tip tool side with respect to the fulcrum shaft.

The first housing is not limited to be formed of two housings, which are the inner housing and the gear housing, as in the above-described example. The first housing may be formed of one housing, or may be formed of three or more housings.

The handle attachment portion is not limited to be indirectly disposed in the outer housing via the securing ring as in the above-described example. The handle attachment portion may be directly disposed in the outer housing or the gear housing. The number of the handle attachment portions is not limited to three, and it may be increased or decreased as necessary. For example, only two right and left handle attachment portions may be disposed or only any one of right or left handle attachment portion may be disposed. The handle attachment portion is not necessarily disposed outside the elastic body.

The auxiliary handle is also not limited to the side handle as in the above-described example, and the size and the shape may be changed as necessary. For example, the auxiliary handle may be in an L shape or in a loop shape. The grip detecting mechanism is not necessarily disposed.

The handle attachment portion and the auxiliary handle are not necessarily disposed.

While the structure in which the first housing is relatively moved in the direction intersecting with the grinding surface is employed in the above-described example, the relative movement of the first housing is not necessarily in the intersecting direction, and may be in the direction perpendicular to the grinding surface. For example, it is possible that the first housing is connected to the second housing via the fulcrum shaft parallel to the final output shaft in a relatively movable manner in the axial direction, the elastic body is interposed above and below the connecting portion with the fulcrum shaft in the first housing, and thus, the first housing is elastically held in a relatively movable manner in the axial direction along the fulcrum shaft.

The grinder may be an AC tool using a commercial power supply, not a DC tool using a battery pack as in the above-described example. The motor is not limited to the brushless motor, and may, for example, be a commutator motor.

The rotary grinding tool of the disclosure is not limited to the grinder. For example, the disclosure is applicable to another rotary grinding tool, such as a polisher or a sander.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A rotary grinding tool comprising:
a first housing including a final output shaft on which a tip tool is detachably mountable and a drive unit that rotates the final output shaft; and
a second housing including a handle portion, wherein
the tip tool that rotates together with the final output shaft, when mounted on the final output shaft, has a grinding surface capable of grinding a workpiece, and
the first housing is connected to the second housing in a relatively movable manner in a direction intersecting with the grinding surface, and is elastically held by an elastic body interposed between the first housing and the second housing at least in the intersecting direction.

2. The rotary grinding tool according to claim 1, wherein
the first housing is connected to the second housing via a fulcrum shaft parallel to the grinding surface.

3. The rotary grinding tool according to claim 2, wherein
the first housing is elastically held by the elastic body on a side of the tip tool with respect to the fulcrum shaft.

4. The rotary grinding tool according to claim 2, wherein
the first housing has a tubular shape, the second housing has a tubular shape overlapping the first housing in a radial direction, and the elastic body has a tubular shape interposed in an overlapping portion between the first housing and the second housing.

5. The rotary grinding tool according to claim 2, wherein
the first housing has a tubular shape extending in a front-rear direction and has the final output shaft oriented in an up-down direction in a front portion of the first housing, the second housing has a tubular shape extending in the front-rear direction coaxially with the first housing, and the fulcrum shaft is disposed in a right-left direction on the first housing.

6. The rotary grinding tool according to claim 5, wherein
the final output shaft projects downward from the first housing, and the tip tool is disc-shaped and orthogonally mounted on a lower end of the final output shaft, and the tip tool having a lower surface having the grinding surface parallel to the fulcrum shaft.

7. The rotary grinding tool according to claim 5, wherein
the first housing accommodates a motor constituting the drive unit and includes a bearing holding portion that holds a bearing of a rotation shaft of the motor in a rear portion of the first housing, and the fulcrum shaft is disposed on right and left side surfaces of the bearing holding portion.

8. The rotary grinding tool according to claim 2, wherein
the fulcrum shaft is elastically held by the second housing via a second elastic body.

9. The rotary grinding tool according to claim 8, wherein
the second elastic body has a ring shape or a tubular shape.

10. The rotary grinding tool according to claim 8, wherein
the second elastic body has a hardness lower than a hardness of the elastic body.

11. The rotary grinding tool according to claim 1, wherein
the second housing is provided with a handle attachment portion for attaching an auxiliary handle.

12. The rotary grinding tool according to claim 11, wherein the handle attachment portion is arranged outside the elastic body.

13. The rotary grinding tool according to claim 12, wherein
the auxiliary handle has a screw portion that threadably engages with a screw-hole portion which is provided in a metallic securing ring externally mounted on the elastic body and passing through the center of the handle attachment portion, wherein
the auxiliary handle is attached on the handle attachment portion by screwing the screw portion into the screw-hole portion.
